(19) United States
(12) Patent Application Publication
(10) Pub. No.: US 2008/0107864 A1
(43) Pub. Date: May 8, 2008

(54) Method of Making a Surface Hydrophobic

(75) Inventors: Hua Zhang, New South Wales (AU); Robert Norman Lamb, New South Wales (AU)

Correspondence Address: FITCH EVEN TABIN AND FLANNERY, 120 SOUTH LA SALLE STREET, SUITE 1600, CHICAGO, IL, 60603-3406, US

(73) Assignee: NewSouth Innovations Pty Limited Rupert Myers Building, Sydney (AU)

(21) Appl. No.: 10/586,074

(22) PCT Filed: Jan. 14, 2005
(86) PCT No.: PCT/AU05/00042

§ 371 Date: Jul. 14, 2006

(30) Foreign Application Priority Data
Jan. 15, 2004 (AU) 2004900174

(51) Int. Cl. B32B 33/00; B05D 3/00

(52) U.S. Cl. 428/141; 427/372.2; 427/384; 427/387

(57) ABSTRACT

A method for rendering a microstructured surface of a substrate hydrophobic comprises a first step of applying to the microstructured surface a coating composition capable of forming a hydrophobic coating having a nanoscale roughness on the microstructured surface. The composition is then cured to form a hydrophobic coating having a nanoscale roughness on the microstructured surface. The resultant surface has both nanoscale roughness and microscale roughness.

### TECHNICAL FIELD

The present invention relates to methods for rendering surfaces hydrophobic.

### BACKGROUND ART

Hydrophobic surfaces, and in particular superhydrophobic surfaces, have many advantageous properties. Hydrophobic surfaces are water proof or water resistant. Superhydrophobic surfaces also display a “self-cleaning” property, in which dirt or bacteria, spores and other microorganisms that come into contact with the surface cannot readily adhere to the surface and are readily washed away by water. Superhydrophobic surfaces are also resistant to attachment by water-soluble electrolytes, such as acids and alkalies, and are also resistant to icing and fouling.

The standard method for measuring the hydrophobicity of a surface is to measure the contact angle θ of a droplet of water on the surface. A surface is usually considered to be hydrophobic if the contact angle of water is greater than 90°. Coatings on which water has a contact angle greater than 90° are referred to as hydrophobic coatings. Surfaces with water contact angles greater than 130° are commonly referred to as superhydrophobic surfaces. Similarly, coatings on which water has a contact angle greater than 130° are commonly referred to as superhydrophobic coatings.

If a surface is rough or heterogeneous, there are usually two contact angles that can be measured. Tilting the surface until the droplet is about to roll off illustrates this phenomenon. The contact angle of the leading edge of the droplet represents the largest measurable contact angle and is called the advancing contact angle or θ_{adv}. The contact angle of the receding edge of the droplet represents the minimum measurable contact angle and is called the receding contact angle or θ_{rec}. The difference between the advancing and receding contact angles is known as the contact angle hysteresis and defines the degree of dynamic wettability.

The contact angle hysteresis of water indicates the stability of a droplet of water on the surface, the lower the contact angle hysteresis the less stable the droplet is and therefore the easier the water droplet slides off the surface.

Methods of forming superhydrophobic coatings, and applying superhydrophobic coatings to surfaces, have been described in the prior art. For example, WO 98/42452 and WO 01/14497 describe methods of forming superhydrophobic coatings. However, the superhydrophobic coatings formed by the methods described in WO 98/42452 and WO 01/14497 have a number of disadvantages, and in particular are generally easily damaged and removed from the surface to which they are applied.

In view of the many practical advantages of rendering surfaces hydrophobic, it would be advantageous to develop alternative methods of rendering the surfaces of a substrate hydrophobic.

### DISCLOSURE OF THE INVENTION

The present inventors have unexpectedly found that a microstructured surface may be rendered hydrophobic by overlaying the microstructured surface with a hydrophobic coating having a nanoscale roughness, and that the resultant coated surface has a greater hydrophobicity than a non-microstructured surface overlayed with the same hydrophobic coating.

Accordingly, in a first aspect, the present invention provides a method for rendering a microstructured surface of a substrate hydrophobic, the method comprising the steps of:
applying to the microstructured surface a coating composition capable of forming a hydrophobic coating having a nanoscale roughness on the microstructured surface; and then
curing the composition to form a hydrophobic coating having a nanoscale roughness on the microstructured surface, such that the resultant surface has both nanoscale roughness and microscale roughness.

In some embodiments of the present invention, a surface of a substrate is treated to form a microstructured surface on the substrate prior to applying to the microstructured surface the coating composition capable of forming a hydrophobic coating having a nanoscale roughness.

Accordingly, in a second aspect, the present invention provides a method for rendering a surface of a substrate hydrophobic, the method comprising the steps of:
treating the surface of the substrate to form a microstructured surface;
   applying to the microstructured surface a coating composition capable of forming a hydrophobic coating having a nanoscale roughness on the microstructured surface; and then
   curing the composition to form a hydrophobic coating having a nanoscale roughness on the microstructured surface, such that the resultant surface has both nanoscale roughness and microscale roughness.

The surface of the substrate may be physically treated to form a microstructured surface. Alternatively, the surface may be treated by applying a coating composition to the surface to form a coating on the surface, wherein the coating has a microstructured surface.

Preferably the resultant surface is superhydrophobic.

In some embodiments, the coating composition capable of forming a hydrophobic coating having a nanoscale roughness comprises one or more compounds of the formula (A):

R¹M(OR)₃ (A)

wherein:
R¹ is a non-polar group,
M is a metal, and
each R is independently selected and is an alkyl group,
   optionally together with one or more additional compounds selected from the group consisting of compounds of the formula (B) and compounds of the formula (C):

M(OR)ₙ (B)

wherein:
M is a metal,
each R is independently selected and is an alkyl group, and
n is 3 or 4;

R¹M(OR)ₘ (C)

wherein:
R¹ is a non-polar group,
M is a metal,
each R is independently selected and is an alkyl group, and
m is 1 or 2.

In formulas (A), (B), and (C), R is typically a C₁₋₁₀ alkyl, such as methyl, ethyl, propyl, etc.

In formula (A), M is typically Si or Zn, more typically Si. In formula (B), M is typically Si, Zn or Al. In formula (C), M may for example be Al or Zn. Compounds of formula (C) include, for example, compounds of the formula R¹Al(OR)₂ or R¹Zn(OR).

In formulas (A) and (C), R¹ may be any non-polar group. R¹ is typically C₁₋₁₀ alkyl, C₃₋₁₀ alkenyl, phenyl, an epoxy group, an acrylate group or an isocyanate group. When R¹ is an alkyl, alkenyl or phenyl group, the alkyl, alkenyl or phenyl group may be optionally substituted by one or more non-polar groups.

The compound of formula (B) may for example be a tetraalkoxysilane, such as tetraethyl orthosilicate (Si(OCH₂CH₃)₄) or tetramethyl orthosilicate (Si(OCH₃)₄).

The hydrophobic coating having a nanoscale roughness is formed by the compounds of formula (A) (and optionally compounds of formulas (B) and (C)) reacting together in a modified sol-gel reaction.

In preferred embodiments, the coating composition capable of forming a hydrophobic coating having a nanoscale roughness comprises one or more tri-functional alkylsilanes, and the hydrophobic coating having a nanoscale roughness is formed by the molecules of the tri-functional alkylsilanes reacting together in a modified sol-gel reaction. Preferably, the coating composition comprises two or more different tri-functional alkylsilanes, the different alkylsilanes having different length alkyl chains. For example, in some embodiments, one of the tri-functional alkylsilanes in the coating composition has an alkyl chain having a length of 3 or less carbon units (i.e. a C₁₋₃ alkyl), and another of the tri-functional alkylsilanes in the coating composition has an alkyl chain having a length of 6 or more carbon units (eg. a C₆₋₃₀ alkyl).

The coating composition comprising the one or more tri-functional alkylsilanes may further comprise a polymer that is capable of chemically bonding to the tri-functional alkylsilane(s) and to the microstructured surface. Preferably, the polymer is a polysiloxane polymer. The coating composition typically further comprises an organic solvent, such as ethyl acetate, butyl acetate, toluene, xylene, methyl ethyl ketone, acetone, hexane, light petroleum, diethylether, or tetrahydrofuran.

When a coating composition comprising the one or more tri-functional alkylsilanes is used in the method of the present invention, the composition is typically cured by allowing the composition to dry at room temperature (eg. about 15° C. to about 30° C.) in the presence of air. However, in some embodiments, curing of the composition may comprise exposing the composition to elevated temperatures, for example, up to about 60 or 80° C.

Preferably the contact angle of water on the resultant hydrophobic surface (i.e the coated surface) is greater than 130°, more preferably greater than 150°, and even more preferably greater than 160°.

In a third aspect, the present invention provides a hydrophobic surface produced by the method of the first or second aspects of the present invention.

In a fourth aspect, the present invention provides a superhydrophobic surface produced by the method of the first or second aspects of the present invention.

In a fifth aspect, the present invention provides an article having at least one surface that has been rendered hydrophobic by the method of the first or second aspects of the present invention.

### MODES FOR CARRYING OUT THE INVENTION

The method of the present invention produces a surface having both a nanoscale and microscale roughness (ie. the resultant surface is both microstructured and nanostructured). The combination of the microstructured surface and the overlying hydrophobic coating having a nanoscale roughness results in surfaces having a greater hydrophobicity than non-microstructured surfaces overlayed with the same coating.

### Coating Composition

Any coating composition that is capable of forming a hydrophobic coating having a nanoscale roughness on the microstructured surface may be used in the method of the present invention.

In some embodiments of the present invention, the coating composition comprises hydrophobic nanoparticles or nanoparticles that are capable of being rendered hydrophobic during curing of the composition. In other embodiments, the coating composition comprises precursors capable of reacting during the curing of the composition to form hydrophobic nanoparticles. In these embodiments, the nanoscale roughness on the resultant surface is provided by the hydrophobic nanoparticles.

In some embodiments, the coating composition comprises hydrophobic nanoparticles formed by a hydrolysis and condensation reaction between one or more compounds of the formula (A):

R¹M(OR)₃ (A)

wherein:
R¹ is a non-polar group,
M is a metal, and
each R is independently selected and is an alkyl group,
   optionally together with one or more additional compounds selected from the group consisting of compounds of the formula (B) and compounds of the formula (C):

M(OR)ₙ (B)

wherein:
M is a metal,
each R is independently selected and is an alkyl group, and
n is 3 or 4;

R¹M(OR)ₘ (C)

wherein:
R¹ is a non-polar group,
M is a metal,
each R is independently selected and is an alkyl group, and
m is 1 or 2.

The hydrolysis and condensation reactions are a modified sol-gel reaction. The hydrophobic nanoparticles can be prepared by reacting the compounds of formula (A) and optionally (B) and (C) in an organic solvent in the presence of a catalyst and a small quantity of water to initiate the hydrolysis reaction.

In some embodiments, the coating composition comprises compounds of formula (A) (and optionally compounds of formulas (B) and (C)), which are capable of reacting together by hydrolysis and condensation reactions to form hydrophobic nanoparticles. In these embodiments of the present invention, during the curing of the coating composition, the solvent in the coating composition is removed from the composition, and the compounds of formula (A), (B) and (C) present in the coating composition react to form hydrophobic nanoparticles, which bind to each other and to the surface, to thereby form a hydrophobic coating having a nanoscale roughness on the microstructured surface.

In preferred embodiments of the present invention, the coating composition comprises one or more tri-functional alkylsilane(s). Tri-functional alkylsilanes are compounds having a silicon atom bonded to an alkyl group and three functional groups capable of undergoing hydrolysis and condensation reactions. Such compounds include tri-alkoxy alkylsilanes of the general formula

R¹Si(OR⁴)₃

wherein:
R¹ is an alkyl group, typically a C₁₋₃₀ alkyl, and each R⁴ is independently selected and is an alkyl group, typically a C₁₋₃ alkyl.

Under suitable conditions, tri-functional alkylsilanes are capable of reacting by a modified sol-gel reaction to form a hydrophobic coating having a nanoscale roughness. The resultant coatings are extremely hydrophobic because the reacted alkylsilane has a hydrophobic alkyl group. For simplicity, the modified sol-gel reaction will now be described in more detail in relation to tri-functional alkylsilanes. However, similar reactions also occur between the compounds of formulas (A), (B) and (C), as defined above.

In a modified sol-gel reaction, the tri-functional alkylsilane reacts to form nanoscale sized covalently bonded networks of reacted alkylsilanes, such as the silsesquioxane or amorphous polysilsesquioxane, or “ormosil”, shown below. Ormosil is an acronym for organically modified sols.

The nano-sized covalently bonded networks of reacted alkylsilanes are hydrophobic nano-sized particles. For convenience, the nanoscale sized covalently bonded networks of reacted alkylsilanes will be referred to below as hydrophobic nanoparticles.

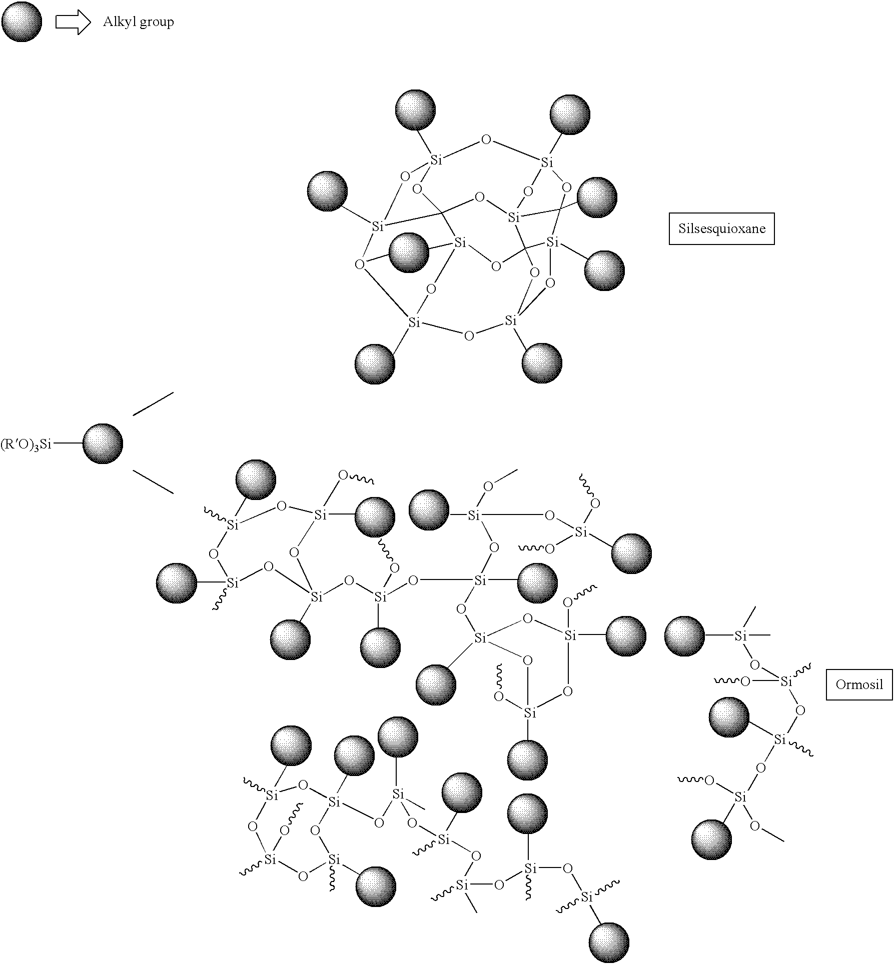

The nanoscale sized covalently bonded networks of reacted alkylsilanes may be joined to other nanoscale sized covalently bonded networks of reacted alkylsilanes to form a covalently bonded network of hydrophobic nanoparticles. On curing, during which any solvents present are removed, a covalently linked network of hydrophobic nanoparticles is formed, producing a hydrophobic coating having a nanoscale roughness on the surface. During this process, the nanoparticles may from agglomerations.

The modified sol-gel reaction consists of two main reactions:
Hydrolysis: where a reactive functional group (for example an alkoxy group in the case of a tri-alkoxy alkylsilane) of the tri-functional alkylsilane is hydrolysed; and
Condensation: where the hydrated tri-functional alkylsilane reacts with another optionally hydrated tri-functional alkylsilane to form a covalently bonded network.

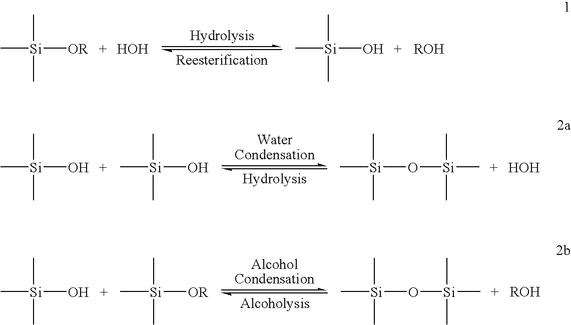

These two reactions are usually concurrent.

In a preferred embodiment of the present invention, the coating composition comprises one or more tri-functional alkylsilane(s), a polysiloxane compound capable of reacting with the alkylsilane(s), an organic solvent, and a catalyst. The present invention will be described in more detail below by reference to this embodiment of the invention. For convenience, tri-functional alkylsilanes will simply be referred to below as “alkylsilanes”.

When such a coating composition is applied to the microstructured surface and exposed to water in the atmosphere, a modified sol-gel reaction occurs forming the hydrophobic coating having a nanoscale roughness. During this process, the alkylsilanes undergo hydrolysis and condensation reactions as discussed above, forming hydrophobic covalently bonded networks (hydrophobic nanoparticles).

The alkylsilane may be any alkylsilane having three functional groups which are capable of undergoing hydrolysis and condensation reactions. Suitable functional groups include acetoxy, enoxy, oxime, alkoxy and amino. The three functional groups on a tri-functional alkylsilane may be the same or different.

The alkyl group on the alkylsilane may be straight chain or branched and may be, for example, methyl, ethyl, propyl, butyl or octyl.

Preferably, the three functional groups are all alkoxy (i.e. the alkylsilane is a tri-alkoxy alkylsilane). Specific tri-alkoxy alkylsilanes for use in the present invention include methyltrimethoxysilane,
methyltriethoxysilane, ethyltrimethoxysilane,
ethyltriethoxysilane or octyltriethoxysilane.

In preferred embodiments of the present invention, the coating composition comprises two or more alkylsilanes having different length alkyl chains. For example the coating composition may comprise an alkylsilane having an alkyl chain length of 3 carbon units or less (i.e. a C₁₋₃ alkyl) and an alkylsilane having an alkyl chain length of 6 carbon units or more (eg. a C₆₋₃₀ alkyl).

The mixture of long and short alkyl chain alkylsilanes significantly enhances the hydrophobicity of the resultant surface. The present inventors have found that when two alkylsilanes having substantially different length alkyl chains are used, the resultant surface is typically superhydrophobic. Without wishing to be bound by theory, it is believed that the different alkylsilanes have a tendency to agglomerate together, thereby forming hydrophobic nanoparticles having different sizes and imparting a greater nanoscale roughness to the resultant surface, increasing the hydrophobicity of the surface.

When a mixture of a short alkyl chain alkylsilane and a long alkyl chain alkylsilane is used, the ratio of short alkyl chain alkylsilane:long alkyl chain alkylsilane may, for example, range from about 7:1 to about 1:1, preferably 5:1, by weight.

Suitable long alkyl chain alkylsilanes include
octyltriethoxysilane, octyltrimethoxysilane,
decyltriethoxysilane, decyltrimethoxysilane,
dodecyltriethoxysilane, and dodecyltrimethoxysilane.

The coating composition comprising one or more tri-functional alkylsilane(s) may also comprise mono- or di-functional alkylsilanes.

Polysiloxane compounds are intrinsically hydrophobic because of the large number of siloxane bonds, and thus contribute to the hydrophobicity of the resultant surface. The polysiloxane compound must be capable of reacting with the alkylsilane(s). Typically, the terminal ends of the polysiloxane compound have a functional group that can react with the alkylsilane(s), for example, the polysiloxane compound can have terminal hydroxy or silanol groups. Alternatively, these functional groups may be present at intervals along the polymer chain.

During curing of the composition, the polysiloxane compound may bind to hydrophobic nanoparticles formed by the hydrolysis and condensation of the alkylsilanes, or to an alkylsilane which then binds to other alkylsilanes to form a hydrophobic nanoparticle, thereby linking the hydrophobic nanoparticles together.

The polysiloxane compound can also typically react with functional groups on the microstructured surface, linking the hydrophobic nanoparticles formed by the hydrolysis and condensation of the alkylsilanes to the microstructured surface. The polysiloxane compound thus contributes to the durability and elasticity of the resultant hydrophobic or superhydrophobic surface.

Suitable polysiloxane compounds include hydroxy terminated polydimethylsiloxane (PDMS), hydroxy terminated polydimethylsiloxane-co-polyphenylmethylsiloxane, hydroxy terminated vinylsiloxane polymer, hydroxy terminated polydiphenylsiloxane, hydroxy terminated polyphenylmethylsiloxane, vinylmethoxysiloxane homopolymer (terminated with a methoxy group at intervals along the polymer chain), polytrifluoropropylmethylsiloxane (silanol terminated), and vinylmethylsiloxane-dimethylsiloxane copolymer (silanol terminated). The coating composition may comprise a mixture of two or more polysiloxane compounds.

The organic solvent may be any inert organic solvent and is preferably ethyl acetate. Other inert organic solvents can be used, however, for example butyl acetate, toluene, xylene, methyl ethyl ketone, acetone, hexane, light petroleum, diethylether, or tetrahydrofuran.

The catalyst catalyses the condensation reactions, thereby causing the hydrophobic coating to cure more rapidly. Any catalyst commonly used for silane condensation reactions may be used, for example tin and zinc catalysts such as dibutyltin dilaurate, zinc octoate and tin octoate.

The catalyst (or a different catalyst) may also catalyse the reaction of the alkylsilane with the polysiloxane compound.

The coating composition may optionally further comprise an adhesion promoter. The adhesion promoter facilitates chemical bonding of the hydrophobic nanoparticles to the microstructured surface and thus increases the durability of the resultant hydrophobic or superhydrophobic surface. Compounds suitable for use as an adhesion promoter include
(3-aminopropyl)triethoxysilane,
(3-aminopropyl)trimethoxysilane and
glycidylpropyltriethoxysilane.

An example of a coating composition for use in the method of the present invention may be prepared as described below.

The coating composition is prepared by mixing an alkylsilane having a short (c<3) alkyl chain, a polysiloxane compound having terminal hydroxy groups, an organic solvent, and catalyst together in a suitable ratio, for example, between about 0.1 to about 0.5% catalyst by weight of the mixture.

The mixture may then be heated to 60° C. for 3 to 6 hrs. The reaction mixture is heated to activate the polysiloxane compound, ie. such that the terminal hydroxy groups of the polysiloxane compound are substituted by an alkylsilane. No other significant reaction of the alkylsilanes occurs at this time because there is no water present to cause hydrolysis of the alkylsilanes. One or more alkylsilane(s) having a long (c>6) alkyl chain is/are then added to the mixture. The resultant coating composition may then be stored in the absence of water or air for some time before use in the method of the present invention.

The coating composition may be applied to a microstructured surface using any technique known in the art, for example, painting, spray coating, dip coating or spin coating. The coating composition is typically applied to the microstructured surface in an amount such that, on curing, a thin layer of the hydrophobic coating having a nanoscale roughness overlays the microstructured surface, thus resulting in a surface having both nanoscale and microscale roughness.

The amount of coating composition applied to a microstructured surface may vary, and a suitable amount to form a hydrophobic coating having nanoscale roughness can readily be determined by a person skilled in the art. In general, any amount of coating composition may be applied, provided that the resultant hydrophobic coating does not cover the microstructure to a thickness such that the resultant surface does not have microscale roughness.

Typically, the coating composition is applied to form a layer of between 0.1 to 1 micron thick, which on drying forms a hydrophobic coating layer less that 1 micron thick. Because of this thin layer, the hydrophobic coating is essentially transparent. This is advantageous as the method of the present invention can be used to render surfaces hydrophobic without significantly changing the colour or appearance of the surface, and without significantly reducing the transmission of light through a transparent or translucent substrate.

Once the coating composition has been applied to the microstructured surface, the composition is cured. Typically, the composition is cured by allowing the composition to dry at room temperature in the presence of air. During the curing, the solvent in the coating composition evaporates, and the composition is exposed to water from the atmosphere. The alkylsilanes in the coating composition react with this water to form hydrophobic nanoparticles via the modified sol-gel reaction discussed above.

Furthermore, during the curing of the composition, the polysiloxane compound reacts with functional groups on the microstructured surface, thereby linking the hydrophobic nanoparticles to the microstructured surface and enhancing the durability of the coating.

### Microstructured Surface

The surface to which the coating composition is applied is microstructured, ie. it has a microscale texture or roughness. Some substrates intrinsically have a microstructured surface, Examples of substrates having surfaces that have an intrinsic microscale roughness include sandstone, some ceramic materials, some cementitious materials and textiles. The nature or extent of this roughness will depend on the material's composition and processing.

For substrates that do not have an intrinsic microscale roughness, a surface of the substrate may be treated to form a microstructured surface (ie. a surface having a microscale roughness). Typically, this is achieved by applying a composition to the surface to form a coating having a microstructured surface. The coating is typically formed by applying a composition comprising microparticles, or smaller particles which react or associate to form microparticles, to the surface. Suitable microparticles include clay particles, cementitious particles, and inorganic oxide particles. The inorganic oxide particles may also be used to impart a colour to the microstructured surface. Suitable inorganic oxides may be selected from the group consisting of iron oxide red, iron oxide black, iron oxide yellow, iron oxide brown, iron oxide green, titanium(IV) oxide, chromium oxide green, and mixtures thereof.

The coating composition for forming a microstructured surface may be applied to the surface using any technique known in the art, for example, painting, spray coating, dip coating or spin coating.

For illustrative purposes, a number of examples of compositions for forming a microstructured surface on a ceramic or cementitious substrate are given below.

### Ceramic Coating

A ceramic surface may intrinsically be a microstructured surface. Alternatively, a microstructured surface may be formed on a ceramic substrate by applying a composition containing microparticles of ceramic material to a surface of the substrate to form a microstructured surface on the substrate. Such a composition may be in the form of a slurry comprising:
(a) clay or grinding microparticles;
(b) a water miscible solvent, for example an alcohol;
(c) water; and
(d) optionally, a water soluble and thermo-degradable polymer.

The slurry may be applied to the surface of, for example, clay work pieces of various shapes and having wet or dry surfaces. The clay work pieces are left to air dry for 3 days, and are then cured in an oven at 1100° C. for 24 hrs to fuse the microparticles to the surface, producing a microstructured surface on the pieces.

For example, a microstructured surface may be formed on a ceramic work piece as follows:
mixing the water and alcohol (in a ratio of from, for example, 0:1 to 3:1) with clay microparticles or grinding microparticles to form a slurry (and optionally adding 1 to 20% wt of a water soluble and thermo-degradable polymer to assist in structuring the surface);
applying the resultant slurry to a wet or dry surface of the clay work piece;
leaving the coated clay work piece at room temperature for 3 days, followed by thermal treatment at 1100° C. for 24 hrs; and then
allowing the coated ceramic work piece to cool.

After cooling to room temperature, the coating composition capable of forming a hydrophobic coating having a nanoscale roughness may be applied to the ceramic microstructured surface. The coated ceramic microstructured surface may then be cured at room temperature for at least 12 hrs, as discussed above, resulting in a hydrophobic or superhydrophobic ceramic surface.

The surface produced by this method has a roughness in both the micro and nano scales, as well as low surface energy. The surface shows high contact angles (>150°) for a water droplet and low contact angle hysteresis (<20°). Thus, a water droplet is easily able to bead on the surface and roll off with minimum vibration.

Such a method may be used to produce hydrophobic or superhydrophobic surfaces on ceramic substrates such as roof tiles, facade tiles and pavers.

### Cementitious Coating

A cementitious surface may intrinsically be a microstructured surface. Alternatively, a microstructured surface may be formed on a cementitious substrate by applying a composition containing microparticles of cementitious material to a surface of the substrate to form a microstructured surface on the substrate.

A composition for forming a cementitious coating having a microstructured surface may be prepared by incorporating cementitious microparticles into a modified sol-gel reaction.

Such a composition may be in the form of a slurry comprising:
(a) a sol made from the hydrolysis and condensation of alkoxy alkylsilanes in alcohol;
(b) cementitious microparticles; and optionally
(c) a colour oxide.

The slurry is applied to a surface, for example, a surface made from a brick or cementitious material such as brick, cement, concrete, mortar, or plaster. Once the resultant microstructured surface has been cured, the coating composition capable of forming a hydrophobic coating having a nanoscale roughness may then be applied.

Typically, the method for applying such a composition to a surface comprises the steps of:
preparing the sol by mixing an alkoxy alkylsilane, alcohol and water (acidified to pH=4 by hydrochloric acid) at 60° C. for 3 hours;
mixing the sol with cementitious microparticles and a colour oxide to form a slurry; and then
applying the slurry to the surface by brushing, rolling or spraying, and then curing the slurry, thereby forming a microstructured surface (alternatively, the slurry can be allowed to set, thereby forming an article having microstructured surfaces which are suitable for applying the coating composition capable of forming a hydrophobic coating having a nanoscale roughness to).

The alkoxy alkylsilane used in the above method may, for example, be methyltrimethoxysilane, methytriethoxysilane, ethyltrimethoxysilane, or ethyltriethoxysilane.

The alcohol may be, for example, ethanol or isopropanol.

Such a method may be used to produce hydrophobic or superhydrophobic surfaces on cementitious substrates such as roof tiles, wall facades, plasterboard, or cementitious surfaces.

### Textiles

The method of the present invention may be applied to textiles having intrinsic microstructured surfaces, for example, cotton, wool, synthetics and blends, utilising the inherent microstructure of woven fibrous material.

Suitable methods for applying the coating compositions capable of forming a hydrophobic coating having a nanoscale roughness to textiles include spray and dip coating.

Experiments by the present inventors have indicated that textile surfaces can be made superhydrophobic without significantly changing their textile feel.

Such a method may be used to produce hydrophobic or superhydrophobic surfaces on textiles used in numerous items such as tents, furnishings, swimwear, outdoor wear, or umbrellas.

Preferred embodiments of the invention will now be described, by way of example only, with reference to the following Examples.

### EXAMPLES

### Example 1

### Coating Composition Capable of Forming a Hydrophobic Coating Having a Nanoscale Roughness

Mix 100 g methyltrimethoxysilane (MTMS), 10 to 200 g hydroxy terminated polydimethylsiloxane (PDMS), 50 to 150 mL ethyl acetate and stir the mixture at 60° C. for 3 to 6 hrs. The mixture is then blended with 10 to 100 g of octyltriethoxysilane, 4 to 40 g of

(3-aminopropyl)trimethoxysilane and 1 to 5 g dibutyltin dilaurate (a catalyst).

This mixture may be stored in an airtight container (for example, a metal drum or bottle) for a number of months prior to use.

### Example 2

### Coating Composition Capable of Forming a Hydrophobic Coating Having a Nanoscale Roughness

Methyltrimethoxysilane (MTMS), hydroxy terminated polydimethylsiloxane (PDMS), ethyl acetate and dibutyltin dilaurate (0.1%) were added in the amounts shown below to a large reaction vessel in an inert atmosphere. The mixture was then stirred and heated at 60° C. for 3 hours. Octyltriethoxysilane and 3-aminopropyltriethoxysilane were then added with stirring.

| Material | % (wt) |
|---|---|
| Methyltrimethoxysilane | 45 |
| Polydimethylsiloxane (—OH term.) | 4.5 |
| Octyltriethoxysilane | 9 |
| ethyl acetate | 40 |
| Dibutyltin dilaurate | 0.5 |
| 3-Aminopropyltriethoxysilane | 1 |

The resultant coating composition may be stored in an airtight container (for example, a metal drum or bottle) for months. Further tin catalyst (0.4%) is added to the composition shortly before applying the composition to a microstructured surface. The mixture of the composition with the tin catalyst may be stored in an airtight container for up to a week prior to use.

### Example 3

### Microstructured Surface Formation—Using Ceramic Materials

Mix 100 g of ethanol, 1 to 20 g of polyethylene oxide (mw˜1,000), and 200 g of clay particles or grindings (microparticle size) to form a slurry. Apply the slurry to a wet surface of a clay workpiece, and then leave the workpiece at room temperature for 3 days. Finally, cure the workpiece at 1100° C. for 24 hrs.

The coating composition described in Example 1 or 2 can then be applied to the microstructured surface of the ceramic workpiece and the coated workpiece is cured at room temperature for at least 12 hrs.

The surface of the ceramic work piece made by this process is extremely water resistant and exhibits a water contact angle of larger than 165°.

### Example 4

### Microstructured Surface Formation—Using Cementitious Material

100 g methyltrimethoxysilane (MTMS), 50 to 400 g ethanol, 50 to 100 g water (pH=4, acidified by HCl) are mixed and stirred at 60° C. for 3 to 6 hrs. The resultant sol is then blended with cement microparticles, and black oxide in a ratio of 3.5:5.8:0.7 to form a slurry, which is applied to a surface of a substrate.

After the slurry has been applied to the surface and cured by heating at 1100° C. for 24 hrs, a coating composition prepared using the method of Example 1 or 2 is applied to the microstructured surface to form a thin film which is 0.1 to 1 micron thick. The resultant surface is then cured in air at room temperature for 8 to 24 hrs.

The superhydrophobic surface made by this process is extremely water resistant and exhibits a water contact angle of larger than 165°.

### Example 5

### Microstructured Surface Formation—Using Textiles

Textile material is sprayed with a coating composition prepared using the method of Example 1 or 2 such that it is 0.1 to 1 micron thick. Alternatively, the textile material is immersed in a diluted solution (5 to 20%) of the coating composition. The composition is cured in air at room temperature for 8 to 24 hrs.

The superhydrophobic surface made by this process is extremely water resistant and exhibits a water contact angle of larger than 150°.

The present invention may be used to form hydrophobic or superhydrophobic surfaces on a variety of substrates. The method can be used to render surfaces of substrates water proof and resistant to icing and fouling.

Although the present invention has been described with reference to particular examples, it will be appreciated by those skilled in the art that numerous variations and/or modifications may be made to the invention as shown in the specific embodiments without departing from the spirit or scope of the invention as broadly described. All such variations and/or modifications are to be considered within the scope of the present invention the nature of which is to be determined from the foregoing description.

In the claims which follow and in the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

1. A method for rendering a microstructured surface of a substrate hydrophobic, the method comprising the steps of:
applying to the microstructured surface a coating composition capable of forming a hydrophobic coating having a nanoscale roughness on the microstructured surface; and then
curing the composition to form a hydrophobic coating having a nanoscale roughness on the microstructured surface, such that the resultant surface has both nanoscale roughness and microscale roughness.

2. The method as claimed in claim 1, wherein the coating composition comprises one or more tri-functional alkylsilanes, and the hydrophobic coating having a nanoscale roughness is formed by the molecules of the tri-functional alkylsilanes reacting together in a modified sol-gel reaction.

3. The method as claimed in claim 2, wherein the coating composition comprises two or more different tri-functional alkylsilanes, the different alkylsilanes having different length alkyl chains.

4. The method as claimed in claim 3, wherein one of the tri-functional alkylsilanes in the coating composition has an alkyl chain having a length of 3 or less carbon units, and another of the tri-functional alkylsilanes in the coating composition has an alkyl chain having a length of 6 to 30 carbon units.

5. The method as claimed in claim 2, wherein the functional groups of the tri-functional alkylsilane(s) are independently selected from the group consisting of acetoxy, enoxy, oxime, alkoxy and amino.

6. The method as claimed in claim 2, wherein the coating composition further comprises a polymer that is capable of chemically bonding to the tri-functional alkylsilane(s) and to the microstructured surface.

7. The method as claimed in claim 6, wherein the polymer is a polysiloxane polymer.

8. The method as claimed in claim 2, wherein the coating composition further comprises an organic solvent.

9. The method as claimed in claim 8, wherein the organic solvent is ethyl acetate, butyl acetate, toluene, xylene, methyl ethyl ketone, acetone, hexane, light petroleum, diethylether, or tetrahydrofuran.

10. The method as claimed in claim 1, wherein the composition is applied to form a hydrophobic coating between about 0.1 and about 1 micron thick.

11. The method as claimed in claim 2, wherein the composition is cured by allowing the composition to dry at about 15° C. to about 30° C. in the presence of air.

12. The method as claimed in claim 2, wherein the composition is cured by allowing the composition to dry at about 60° C. to about 80° C. in the presence of air.

13. The method as claimed in claim 1, wherein a contact angle of water on the resultant surface is greater than 130°.

14. The method as claimed in claim 1, wherein a contact angle of water on the resultant surface is greater than 150°.

15. The method as claimed in claim 1, wherein a contact angle of water on the resultant surface is greater than 160°.

16. A method for rendering a surface of a substrate hydrophobic, the method comprising the steps of:
treating the surface of the substrate to form a microstructured surface;
applying to the microstructured surface a coating composition capable of forming a hydrophobic coating having a nanoscale roughness on the microstructured surface; and then
curing the composition to form a hydrophobic coating having a nanoscale roughness on the microstructured surface, such that the resultant surface has both nanoscale roughness and microscale roughness.

17. The method as claimed in claim 16, wherein the surface of the substrate is physically treated to form a microstructured surface.

18. The method as claimed in claim 16, wherein the surface is treated by applying a coating composition to the surface to form a coating on the surface, wherein the coating has a microstructured surface.

19. The method as claimed in claim 18, wherein the microstructured surface is formed by applying a composition comprising microparticles, or smaller particles capable of forming microparticles, to the surface.

20. The method as claimed in claim 19, wherein the microparticles are clay microparticles, cementitious microparticles, or inorganic oxide microparticles.

21. The method as claimed in claim 16, wherein the composition is applied to form a hydrophobic coating between about 0.1 and about 1 micron thick.

22. A hydrophobic or superhydrophobic surface produced by the method of claim 1.

23. A hydrophobic or superhydrophobic surface produced by the method of claim 16.

24. An article having at least one surface that has been rendered hydrophobic according to the method of claim 1.

25. An article having at least one surface that has been rendered hydrophobic according to the method of claim 16.
